(19) United States
(12) Patent Application Publication
(10) Pub. No.: US 2018/0232569 A1
(43) Pub. Date: Aug. 16, 2018

(54) SYSTEM AND METHOD FOR IN MOTION IDENTIFICATION

(71) Applicant: FST21 Ltd, Holon (IL)

(72) Inventor: SHAHAR BELKIN, Kibbutz Brur Chayil (IL)

(73) Assignee: FST21 Ltd, Holon (IL)

(21) Appl. No.: 15/752,270

(22) PCT Filed: Aug. 22, 2016
(86) PCT No.: PCT/IL2016/050916

§ 371 Date: Feb. 13, 2018

Related U.S. Application Data
(60) Provisional application No. 62/208,832, filed on Aug. 24, 2015.

(51) Int. Cl. G06K 9/00; G07C 9/00; G06K 9/62; G06T 7/292

(52) U.S. Cl. CPC G06K 9/00348; G07C 9/00158; G07C 9/00166; G06K 9/00288; G06T 7/292; G06T 2207/30201; G06K 9/6292

(57) ABSTRACT

A system according to the invention may include: an access control system and a central control unit. The access control system may include: one or more entry checkpoints to a premises, a plurality of controllable gates, a plurality of cameras and a local control unit. The local control unit may be configured to: obtaine, for at least one camera from the plurality of cameras, a stream of images of one or more persons approaching a checkpoint, and extract from the obtained images dynamic identification data. The local control unit may further be configured to stream the extracted dynamic identification data to the central control unit. The central control unit may be configured to: create a motion based identification vector from the extracted dynamic identification data, compare the motion based identification vector to stored identification motion based vectors, and calculate one or more confidence level scores for identifying the one or more persons approaching the checkpoint.

### BACKGROUND OF THE INVENTION

Access control systems known in the art provide various levels of security and certainty as to whether the right access permission was granted to the right person. Basic access control systems require a single identity ascertaining component, either ‘something you have’ (e.g. a key, an RFID card, a passport and the like) or ‘something you know’ (e.g. numeric code, password and the like) to be presented to the access control system in order to authorize access. In more secured systems both components may be required in order to authorize access to an access controlled location. Such systems are subject to fraud as each of the components can relatively easily be stolen, duplicated, or otherwise being misused.

Higher level of security of access control is provided by systems comprising identification of biometric parameter(s) such as face recognition, fingerprint identification, voice recognition and the like. While these systems are more immune to misuse, they suffer of several drawbacks such as the need to enroll to each access control system, and a limitation on the number of enrolled users that makes such access control systems suitable only for small to medium size businesses and facilities. Furthermore, biometric recognition systems are used only as identity verification systems. Currently when using biometric solutions for large populations (large databases of enrolled people) the only available solution is a two factor authentication, meaning identification based on a document and verification (1 to 1) by using biometrics. This is a result of the False Accept Rate (FAR) that is very large when using large biometric databases.

### SUMMARY

Aspects of the invention may be directed to a system and method of in motion identification of one or more persons approaching a check point or a controlled entrance, for example, in airports, military bases, banks, government offices, etc. A system according to some embodiments of the invention may include: an access control system and a central control unit. In some embodiments the access control system may include one or more entry checkpoints to a premises, a plurality of controllable gates, a plurality of cameras and a local control unit. The local control unit may be configured to obtained, from at least one camera from the plurality of cameras, a stream of images of one or more persons approaching a checkpoint and extract from the obtained images dynamic identification data. The local control unit may further be configured to stream the extracted dynamic identification data to the central control unit.

In some embodiments, the central control unit may be configured to create a motion based identification vector from the extracted dynamic identification data, compare the motion based identification vector to stored motion based identification vectors, and calculate one or more confidence level scores for identifying the one or more persons approaching the checkpoint.

A method according to some embodiments of the invention may include: obtaining a stream of images of one or more persons approaching a checkpoint, extracting from the obtained images dynamic identification data and static identification data and streaming the extracted data to a central control unit. The method may further include comparing the extracted static identification data with enrolment static data saved on a database associated with the central control unit, determining an identity of the person based on the comparison, creating a motion based identification vector from the extracted dynamic identification data and associating the created motion based identification vector with the identified person.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram of a system for in motion identification according to one embodiment of the present invention;

FIG. 2 is a flowchart of a method of in motion identification learning stage according to some embodiments of the present inventions;

FIG. 3A is a flowchart of a method of in motion identification according to some embodiments of the invention; and

FIG. 3B is a flowchart of a method of in motion identification according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

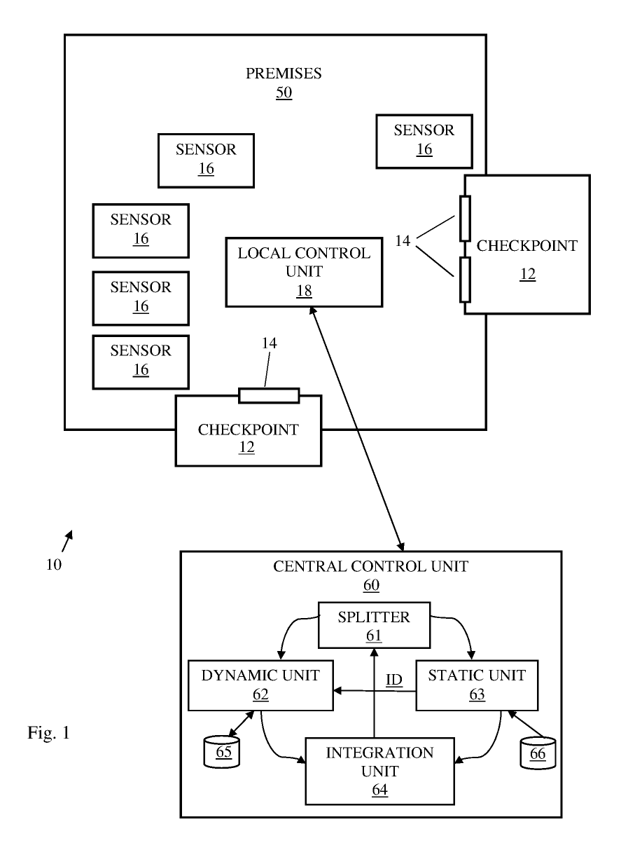

Reference is made to FIG. 1 which is a schematic block diagram of a system 10 for in motion identification according to some embodiments of the present invention. System 10 may comprise one or more entry checkpoints 12 to premises 50, a plurality of controllable gates 14, a plurality of sensors 16 (e.g., video cameras) and at least one Local Control Unit (LCU) 18. Checkpoint 12 may be located next to controllable gate 14 and may be in operative connection with it. Checkpoint 12 may comprise and/or be associated with a plurality of sensors 16 such as video camera, microphone, electronic weigh scale, proximity sensor, infra-red (IR) sensor, a biometric scanner (such as, for example, a fingerprint scanner) and the like. Checkpoint 12 may be constructed to allow a person, who wishes to enter or exit premises 50, to stand close to checkpoint 12 or enter into it or otherwise be in a position that allows system 10 to examine the person by one or more sensors 16, such as taking his still picture and/or his video picture, listen to his vocal output, weighing his weight and the like.

According to some embodiments, checkpoint 12 may also be constructed to prevent a person from entering premises 50 via controllable gate 14 if authorization for entry was not given and/or to prevent a person from exiting premises 50 if exit authorization was not given. Controllable gate 14 may be a door system that is openable only upon authorization from system 10.

One or more sensors 16 may be a video camera, such as an IP camera, adapted to capture a stream of images of a person approaching checkpoint 12. The captured video stream or stream of images, may be preprocessed at LCU 18 (also referred to as IMID agent), to extract dynamic identification data, static identification data and/or metadata from the stream of images or video stream and send the extracted data to a Central Control Unit (CCU) 60. The extracted dynamic identification data and the static identification data may be aggregated to form aggregated data. Dynamic identification data refers to any data extractable from a difference between two or more consecutive images in a stream of images that may serve for identification of a person. For example, dynamic identification data may include gait, head motion, body size, and the like. Static identification data may refer to any data extracted from a still image of a person or from a biometric scan, usually a face image, or a biometric scan (e.g. fingerprint), that may serve for identification of a person.

According to some embodiments, CCU 60 may be a cloud server and may be in operational communication with one or more LCU's 18 of one or more premises 50, via a network, such as the Internet. CCU 60 may comprise, according to some embodiments, a data splitter 61, configured to direct the aggregated data received from one or more LCU's 18 to a static data processing unit 63 and to dynamic identification processing unit 62 configured to process dynamic identification data obtained by one or more sensors 16.

According to some embodiments, static data processing unit 63 may be configured to extract from the data received from data splitter 61, static identification data such as face recognition data (e.g. face dimensions, such as distance between temples, distance between eyes, and the like) and biometric data, such compare static data received from data splitter 61 to pre obtained and pre-stored static data (e.g. enrolment static data or data obtained during prior uses of system 10), stored on static enrolment database 66, in order to retrieve the identity of one or more persons in one or more premises 50. The retrieved identity may be sent to identification integration unit 64.

According to some embodiments, dynamic identification processing unit 62 may be configured to extract from the data received from data splitter 61, dynamic identification data such as gait, head movement, posture and other motion dynamics and full body information to create a motion based identification vector for one or more persons approaching checkpoint 12 in premises 50. The motion based identification vector may be stored in dynamic database 65. Dynamic database 65 may be configured to store all the motion based identification vectors created by dynamic identification processing unit 62. It should be appreciated that dynamic database may be updated upon each entry or exit attempt via checkpoint 12 in premises 50. In some embodiments, static enrolment database 66 and dynamic database 65 may be the same database configured to store both motion based identification vectors and static data related to persons authorized to enter premises 50 (and/or persons banned from entering premises 50).

According to some embodiments, dynamic identification processing unit 62 may receive from static data processing unit 63 the retrieved identity of the person or persons approaching checkpoint 12, thus allowing dynamic identification processing unit 62 to apply a machine learning algorithm on the dynamic data extracted and associate the dynamic vector to the identified person. According to some embodiments, after an initial learning period, e.g. after a predefined number of motion based identification vectors have been created and stored for a specific identified person, an identification of a person may be done based on comparing a new motion based identification vector to previously obtained and stored motion based identification vectors and determining the correlation between such vectors. According to some embodiments, dynamic identification processing unit 62 may send a proposed identity of the person to identification integration unit 64.

According to some embodiments, identification integration unit 64 may apply a fusion function configured to combine the proposed identity received from the static data processing unit, and the proposed identity received from the dynamic identification processing unit, and determine the identity of the person or persons approaching checkpoint 12.

According to some embodiments, once an identity has been determined by identification integration unit 64, the determined identity may be returned to LCU 18 in order to, for example, provide the identity via a communication channel to a third party system (not shown) located in or proximal to LCU 18 for providing identity based services. According to some embodiments, once an identity has been determined by identification integration unit 64, the determined identity may be returned to LCU 18 in order to determine whether the identified person is authorized to pass through checkpoint 12. According to other embodiments, the determined identity may be sent to LCU 18 together with an indication whether the identified person is authorized to pass through checkpoint 12.

According to some embodiments, once an identity has been determined by identification integration unit 64, the determined identity may be provided via a communication channel such as a network, to a third party system for example in the cloud (not shown) for providing identity based services.

According to embodiments of the present invention, units 62, 63 and 64 may all be embedded in a single processor, or may be separate processors. According to some embodiments database 66 and database 65 may be stored on a single storage or memory, or may be stored on separate storage devices of CCU 60.

LCU 18 may include interface means (not shown) to controllable gate 14, to sensors 16, to a loudspeaker and a display (not shown) located in or proximal to checkpoint 12. LCU 18 may further include data storage means (not shown) to hold data representing authorization certificates, data describing personal aspects of people which are usually authorized to enter and exit premises 50, etc. LCU 18 may further comprise active link to at least one CCU 60.

CCU 60 may typically be located remotely from premises 50 and be in active communication with system 10 via LCU 18.

CCU 60 may include a non-transitory accessible storage resources programs, data and parameters that when executed, read and/or involved in computations, enable performance of operations, steps and commands described in the present specification.

Identification based on dynamic identification data, also referred to as Visual Dynamic Identification (VDID) or In Motion Identification (IMID) may assure accurate identification, while the individual is moving freely, and does not have to queue up at checkpoint 12 to be identified. Based on a variety of non-contact visual static and dynamic parameters, assuring the reliability of the non-intrusive identification.

According to embodiments of the present invention, data representing identity parameters, authorization granted to person(s) to enter certain premises and credentials may be stored, collected, processed and fused by CCU 60 in the cloud. In some embodiment, authorization for certain person to access certain premises may be decided—granted or not granted by CCU 60 or by LCU 18 based on the accumulated and fused data. Visual Dynamic Identification assures accurate identification, while the individual is moving freely, and does not have to queue up to be identified. Based on a variety of non-contact visual static and dynamic parameters, assuring the reliability of the non-intrusive identification. The non-contact parameters may include gait, head motion, body size, and other.

IMID (or VDID) is based upon the Machine-learning paradigm and requires a learning phase to “learn” each person in the course of time.

In order to achieve In Motion Identification for very large data bases, a multi-factor fusion approach for person identification is needed and will be used. Identification will be performed via a two tier process: (1) pre-processing next to camera and (2) processing and identification. The cloud processing and identification may be performed as two fold recognition algorithms. The first stage may be an initial static identification (e.g. based on face recognition). The second stage may be a learning algorithm, based on deep learning research and may be based on full body recognition and dynamics (body motion). The additional visual elements may enhance the accuracy of the recognition and ensure positive identification, when all the information is integrated, the learning algorithm may create a positive, secure, highly reliable In Motion Identification for large data bases.

In some embodiments, a fusion between the static and dynamic identification may create an identification that may have very low false detection rates even for very large data bases (millions of enrolled users). Furthermore, the fusion between static and dynamic identification may reduce the system's sensitivity to variations in pose and posture. For example, when head pose is not upright but tilting at an angle of 20 degrees from the vertical. In addition, the static and dynamic identification may provide better protection against fraud attempts.

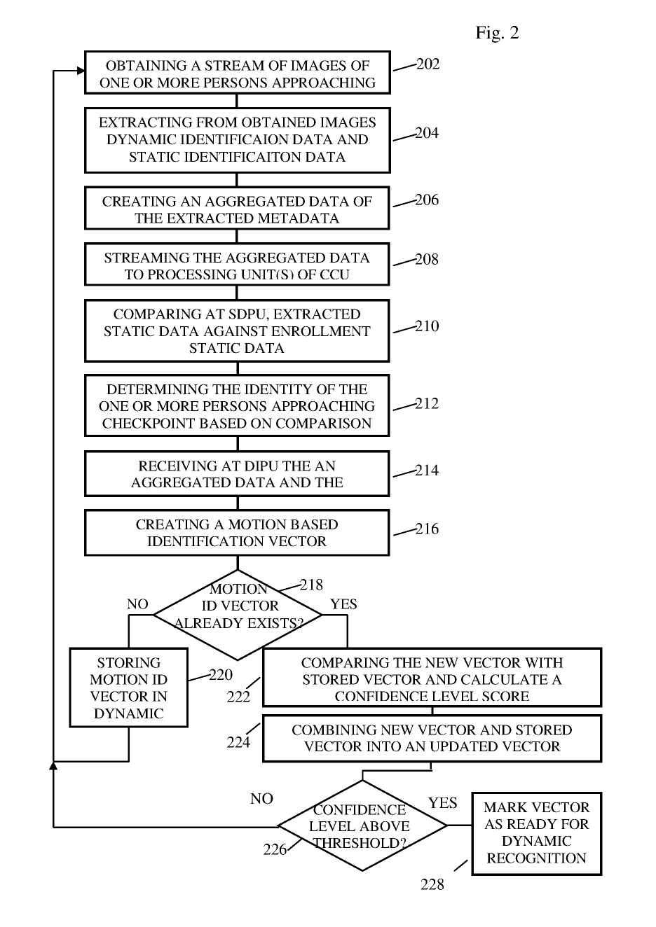

Reference is now made to FIG. 2 which is a flowchart of a method of IMID learning phase according to embodiments of the present invention. The method of FIG. 2 may be performed by system 10.

As seen in block 202, an embodiment of the invention may include obtaining a stream of images, by a camera, such as an IP camera, of one or more persons approaching a checkpoint (e.g., checkpoint 12) or access point and transmitting the obtained stream of images to a Local Control Unit, such as LCU 18 described above. It should be appreciated that additional static identification data may be obtained by sensors (such as sensors 16 in FIG. 1) located in the vicinity of checkpoint (such as checkpoint 12 in FIG. 1).

As seen in blocks 204 and 206, embodiments of the invention may further include extracting from the obtained images dynamic identification data and static identification data and creating at the local control unit (e.g., LCU 18) aggregated data of the extracted dynamic and static identification data (e.g., metadata) received from the camera and/or from other or additional sensors.

The aggregated data may be, according to some embodiments, sent via, for example, a network such as the internet, to a remote control unit such as CCU 60 in FIG. 1. According to some embodiments, CCU may be a cloud server.

As seen in block 208, the aggregated data may be sent to processing units of CCU 60, such as static data processing unit (SDPU) 63 and dynamic identification processing unit (DIPU) 62.

According to some embodiments, upon receipt of the aggregated data at SDPU (e.g., dynamic database 63 in FIG. 1), SDPU 63 may compare extracted static data, such as face recognition data extracted from still images, biometric scans etc. against enrollment static data stored in static database (e.g., static database 66 in FIG. 1) to determine the identity of one or more persons approaching checkpoint 12 (see blocks 210 and 212).

As seen in blocks 214 and 216, the aggregated data, and if available, the SDPU determined identity of the one or more persons, may be streamed to DIPU (e.g., DIPU 62 in FIG. 1) in which a motion based identification vector is created, based on dynamic identification data in the aggregated data. When the identified person based on the SDPU does not have a previous motion based identification vector associated to that person stored in the dynamic identification database (65 in FIG. 1), the created motion based identification vector may be stored in the dynamic identification database and may be associated to the identified person (see block 220). When the identified person already has a motion based identification vector associated to him/her, the new vector may be compared with the previously stored motion based identification vector and a confidence level score may be calculated. The confidence level score may be calculated by calculating the correlation between the stored motion based identification vector and the new obtained motion based identification vectore (see block 222) and the new motion based identification vector may be combined with the stored motion based identification vector into an updated motion based identification vector and the updated motion based identification vector may be stored in dynamic identification database 65 (see block 224).

According to some embodiments, when the calculated confidence level score is below a predefined threshold score, the motion based identification vector is not yet reliable enough in order to serve for dynamic recognition and further machine learning is required. When the calculated score is above the predefined threshold, then the motion based identification vector may be marked as ready for dynamic recognition (see blocks 226 and 228).

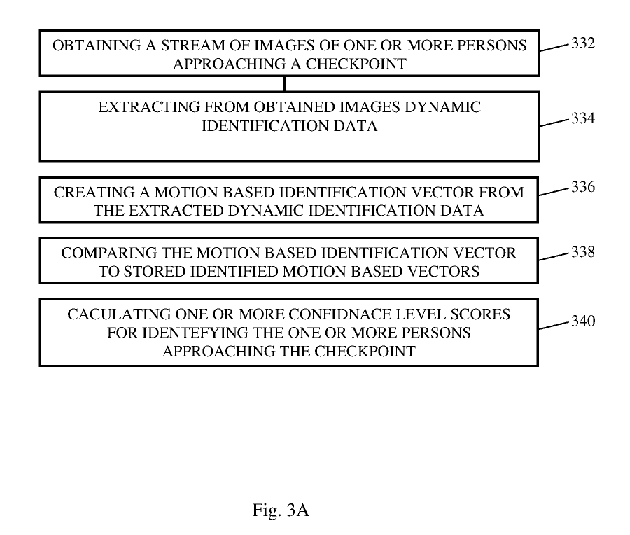

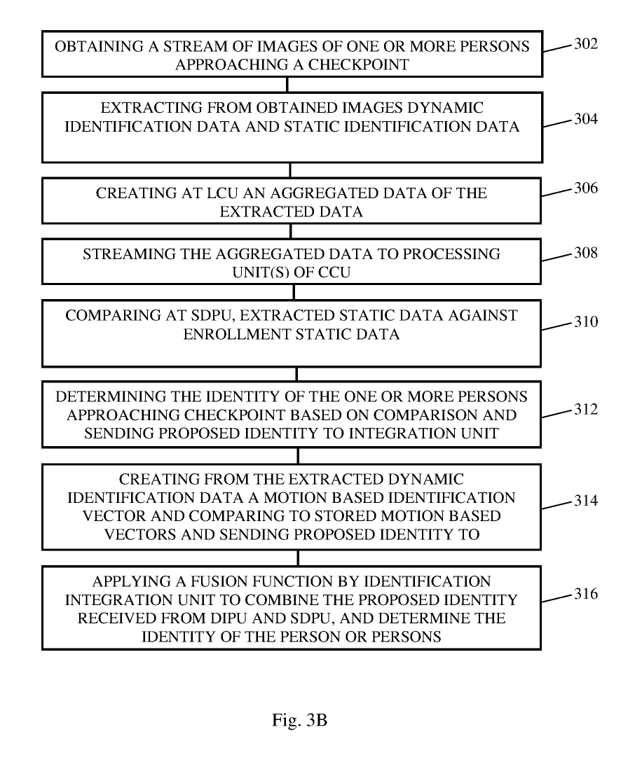

Reference is made to FIG. 3A which is a flowchart of a method of in motion identification according to some embodiments of the invention. The method may be performed by system 10. As seen in block 332, an embodiment of the invention may include obtaining a stream of images of one or more persons approaching a checkpoint. The obtained stream of images, may be received from a video camera, such as an IP camera. The obtained stream of images may be transmitted to a Local Control Unit, such as LCU 18 described above.

As seen in block 334, an embodiment of the invention may include extracting from the obtained images dynamic identification data. LCU 18 may extract from the stream of images dynamic identification data, such as, gait, head motion, body size, and the like. The extracted dynamic identification data may be transmitted to CCU 60.

As seen in block 336, an embodiment of the invention may include creating a motion based identification vector from the extracted dynamic identification data (e.g., by CCU 60). For example, dynamic identification unit 62 may create a motion based identification vector that may include parameters related to the gait, head motion, body size, of the person approaching checkpoint 12 and the like.

As seen in block 336, an embodiment of the invention may include comparing the created motion based identification vector to stored identified motion based identification vectors. For example, CCU 60 or dynamic identification unit 62 may compare the created identification vector one or more motion based identification vectors stored in, for example, dynamic database 65, for already identified persons. Dynamic database 65 may include lookup tables associating identities of persons to stored motion based identification vectors.

As seen in block 336, an embodiment of the invention may include calculating one or more confidence level scores for identifying the one or more persons approaching the checkpoint. The confidence level score may be calculated by calculating a correlation between the stored motion base identification vector and the newly created motion base identification vector.

Reference is now made to FIG. 3B which is a flowchart of a method of in motion identification according to embodiments of the present invention. The method of FIG. 3 may be performed by system 10.

As seen in block 302, a stream of images of one or more persons approaching a checkpoint or access point, may be obtained by a camera, such as an IP camera, and the captured stream of images may be transmitted to a Local Control Unit, such as LCU 18 described above. It should be appreciated that additional static identification data may be obtained by sensors (such as sensors 16 in FIG. 1) located in the vicinity of checkpoint (such as checkpoint 12 in FIG. 1).

As seen in blocks 304 and 306, embodiments may further include extracting from the obtained stream of images dynamic identification data and static identification data and creating, at the local control unit, aggregated data of the extracted dynamic identification data and static identification data received from the camera and/or from other or additional sensors.

The aggregated data may be, according to some embodiments, sent via, for example, a network such as the internet, to a remote control unit such as CCU 60 in FIG. 1. According to some embodiments, CCU 60 may be a cloud server.

As seen in block 308, the aggregated data may be sent to processing units of CCU 60, such as static data processing unit (SDPU) 63 and dynamic identification processing unit (DIPU) 62. In some embodiments, the aggregated data may be split by a splitter included in CCU 60 (e.g., splitter 61) into the extracted dynamic identification data and static identification data. Splitter 61 may be configured to sent the extracted dynamic identification data to DIPU 62 and the extracted static identification data to SDPU 63.

According to some embodiments, upon receipt of the extracted static identification data at SDPU 63, SDPU 63 may compare the extracted static data, such as face recognition data extracted from still images, biometric scans etc. against enrollment static data stored in static database (e.g., static database 66 in FIG. 1) to determine the identity of one or more persons approaching checkpoint 12 (see blocks 310 and 312).

As seen in block 314, the dynamic identification data may be received from splitter 61 at DIPU (e.g., DIPU 62 in FIG. 1). DIPU may create a motion based identification vector from the dynamic identification data and may compare the created motion based identification vector to stored motion based identification vectors (stored in dynamic database 65) to determine the identity of one or more persons approaching checkpoint. The retrieved identity may be sent to identification integration unit 64.

According to some embodiments, dynamic identification processing unit 62 may be configured to create from the dynamic identification data received from data splitter 61, a motion based identification vector comprising parameters related to at least one of: gait, head movement, posture and other motion dynamics and full body information of one or more persons approaching checkpoint 12 in premises 50. The motion based identification vector may be stored in dynamic database 65. Dynamic database 65 may be configured to store all the motion based identification vectors created by dynamic identification processing unit 62. It should be appreciated that dynamic database may be updated upon each entry or exit attempt via checkpoint 12 in premises 50.

As seen in block 316 according to some embodiments, identification integration unit 64 may apply a fusion function configured to combine the proposed identity received from the static data processing unit (e.g., SDPU 63), and the proposed identity received from the dynamic identification processing unit (e.g., DIPU 61), and determine the identity of the person or persons approaching checkpoint 12. The fusion function may check whether the proposed identity received from DIPU 62 and the proposed identity received from SDPU 63 are identical and if they are identical to return to LCU 18 the identity of the one or more persons at checkpoint 12. According to some embodiments, other or additional information may be send to LCU 18, such as for example authorization to enter/exit premises 50 etc.

In some embodiments, when the proposed identities received from DIPU 62 and from SDPU 63 are not identical, integration unit 64 may provide a probability of identification based on the confidence level associated by DIPU 62 to the proposed identity and the confidence level associated by SDPU 63 to the proposed identity. According to some embodiment, when the probability of identification is below a predefined threshold, further data may be required and additional aggregated data may be required in order to verify the identity of the one or more persons at checkpoint 12.

According to some embodiments, once an identity has been determined by identification integration unit 64, the determined identity may be returned to LCU 18.

Unless explicitly stated, the method embodiments described herein are not constrained to a particular order in time or chronological sequence. Additionally, some of the described method elements may be skipped, or they may be repeated, during a sequence of operations of a method.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A system for in motion identification, comprising:
an access control system; and
a central control unit,
wherein the access control system, comprises:
one or more entry checkpoints to a premises;
a plurality of controllable gates;
a plurality of cameras; and
a local control unit configured to:
obtain, from at least one camera from the plurality of cameras, a stream of images of one or more persons approaching a checkpoint;
extract from the obtained images dynamic identification data; and
stream the extracted dynamic identification data to the central control unit,
and wherein, the central control unit is configured to:
create a motion based identification vector from the extracted dynamic identification data;
compare the motion based identification vector to stored identified motion based vectors; and
calculate one or more confidence level scores for identifying the one or more persons approaching the checkpoint.

2. The system of claim 1, wherein the central control unit comprises a dynamic identification processing unit, and wherein the dynamic identification processing unit is configured to:
create the motion based identification vector from the extracted dynamic identification data;
compare the motion based identification vector to the stored identified motion based vectors; and
calculate the one or more confidence level scores for identifying the one or more persons approaching the checkpoint.

3. The system of claim 1 or 2, wherein the central control unit comprises a static data processing unit, and wherein the static data processing unit is configured to:
receive from the local controller static identification data extracted from the obtained stream of images;
compare the extracted static identification data with enrolment static data; and
determine the identity of the one or more persons approaching checkpoint based on the comparison.

4. The system of claim 3, wherein the local controller is configured to:
combine the extracted dynamic identification data with the extracted static identification data, to form a combined data; and
stream the combined data to the central control unit,
and wherein the central control unit further comprises a splitter configured to split the streamed combined data and direct the dynamic identification data to the dynamic identification processing unit and the static identification data to the static data processing unit.

5. The system according to any one of claims 3-4, wherein the dynamic identification processing unit is further configure to:
receive from the static data processing unit the determined identity of the one or more persons approaching checkpoint;
determine if a motion based identification vector was stored for each of the identified one or more persons;
compare the stored motion based identification vector of each identified person with the created motion based vector; and
calculate one or more confidence level scores for identifying the one or more persons approaching the checkpoint based on the comparison.

6. The system according to claim 5, wherein the dynamic identification processing unit is further configured to combine the stored motion based identification vector with the created motion based identification vector to form an updated motion based identification vector.

7. The system according to any one of claims 3-6, wherein the central control unit further comprises an identification integration unit configured to:
receive from the static data processing unit the determined identity of the person;
receive from the dynamic identification processing unit a proposed identity having a confidence level score higher than a threshold score; and
determine the identity of the person based on the received identity and the proposed identity.

8. A method of in motion identification, comprising:
obtaining a stream of images of one or more persons approaching a checkpoint;
extracting from the obtained images dynamic identification data;
creating a motion based identification vector from the extracted dynamic identification data;
comparing the created motion based identification vector to stored identification motion based vectors; and
calculating one or more confidence level scores for identifying the one or more persons approaching the checkpoint based on the comparison.

9. The method of claim 8, further comprising:
extracting from the obtained images static identification data;
comparing the extracted static identification data with enrolment static data; and
determining the identity of the one or more persons approaching checkpoint based on the comparison.

10. The method of claim 9, further comprising:
determining if a motion based identification vector was stored for each of the identified one or more persons;
comparing stored motion based identification vector of each identified person with the created motion based identification vector; and
calculating one or more confidence level scores for identifying the one or more persons approaching the checkpoint based on the comparison.

11. The method of claim 10, further comprising:
combining the stored motion based identification vector with the created motion based identification vector to form an updated motion based identification vector.

12. A method of in motion identification, comprising:
obtaining a stream of images of a person approaching a checkpoint;
extracting from the obtained images dynamic identification data and static identification data;
streaming the extracted data to a central control unit;
comparing the extracted static identification data with enrolment static data saved on a static database associated with the central control unit;
determining an identity of the person based on the comparison; creating a motion based identification vector from the extracted dynamic identification data;
associating the created motion based identification vector with the identified person.

13. The method of claim 12, further comprising:
receiving, from a dynamic database associated with the central control unit, a stored motion based identification vector previously associated with the person;
comparing the created motion based identification vector and the stored motion based identification vector; and
calculating one or more confidence level scores for identifying the person based on the comparison.

14. The method of claim 13, further comprising:
combining the created motion based identification vector and the stored motion based identification vector into an updated motion based identification vector.

15. The method of claim 14, further comprising:
storing the updated identification vector associated with the person in the dynamic database.
